(19) United States
(12) Patent Application Publication
(10) Pub. No.: US 2025/0392921 A1
(43) Pub. Date: Dec. 25, 2025

(54) SYSTEMS AND METHODS FOR RADIO ENVIRONMENT NOTIFICATION

(71) Applicant: Huawei Technologies Co., Ltd., Shenzhen (CN)

(72) Inventors: Xi Zhang, Shenzhen (CN); Jianglei Ma, Ottawa (CA); Xiaoyan Bi, Shanghai (CN); Wen Tong, Ottawa (CA)

(21) Appl. No.: 19/301,197

(22) Filed: Aug. 15, 2025

Related U.S. Application Data
(63) Continuation of application No. PCT/CN2023/077032, filed on Feb. 18, 2023.

(51) Int. Cl. H04W 16/28; H04L 5/00; H04W 56/00

(52) U.S. Cl. CPC H04W 16/28; H04L 5/0051; H04W 56/0015

(57) ABSTRACT

A radio environment notification method is provided that includes broadcasting a first notification in a beam specific manner that includes information about at least one radio path or at least one radio object within the coverage area of a base station beam. A second notification is transmitted in a UE specific manner that may pertain to configuration for storage or utilization, or both, of radio path or radio object information at one UE.

### CROSS-REFERENCE TO RELATED APPLICATIONS

This application is a continuation of International Application No. PCT/CN2023/077032, filed on Feb. 18, 2023, the disclosure of which is hereby incorporated by reference in its entirety.

### TECHNICAL FIELD

The present disclosure relates generally to wireless communications, and in particular to systems and methods for notification of radio environment information.

### BACKGROUND

Positioning in Long Term Evolution (LTE) and New Radio (NR) supports a base station or network notifying a user equipment (UE) regarding certain information. A first category of information is transmission behavior at the base station or a network the base station is part of. Transmission behavior information may include transmit beam direction of a positioning reference signal (PRS) resource and relative power offsets across PRS resources for a given azimuth and elevation angle. Such information is targeted at enabling and improving beam-based positioning. For example, this information may allow comparison of reference signal received power (RSRP) measured from multiple PRS resources. A second category of information is expected radio propagation conditions between the base station or network and the UE. This may include information such as expected general multi-path conditions of a current area around the UE, expected likelihood of having line-of-sight (LOS) path between one transmission and reception point (TRP) and the UE, expected angle of arrival (AoA) or angle of departure (AoD), or both, and uncertainty in AoD or AoA, or both, for one UE at a current location for the UE to receive or the base station or network to transmit one PRS resource. It should be noted that throughout this disclosure the terms “multi-path” and “radio path” as used interchangeably. Such information is targeted at improving positioning accuracy, for example, dropping any non-LOS (NLOS) paths and only keeping LOS paths during positioning. The second category of information may be considered one way of characterizing the radio propagation environment under consideration based on information such as observed channel properties as opposed to the radio object directly.

FIG. 1 illustrates examples of several types of information that may be provided to the UE by the base station or network. FIG. 1 shows a portion of a communication system 10 including a first base station 20, a second base station 30 and a UE 40. An object 24 that may act as a reflector, attenuator, or have no effect on a radio path is also shown located between the first base station 20 and the UE 40. A base station beam 22 is shown at the first base station 20 having an AoD for when the base station beam is transmitting from the first base station 20. A UE beam 42 is shown at the UE 40 having an AoA for when the UE beam 42 is receiving at the UE 40. A relative power offset 32 is shown for transmission on one base station beam 34 at the second base station 30 as compared to an adjacent base station beam 36 at the second base station 30. Another type of information is “LOS likelihood” 44 that may indicate the likelihood of a LOS path between the second base station 30 and the UE 40.

The assistance information provided by the base station or network may facilitate the UE to improve positioning accuracy and reduce an ambiguity region with regard to where the UE is located.

Several methods are being considered with regard to conveying from the base station or network to the UE a sensed and/or acquired radio map or radio environment that indicates radio objects for which the UE should be advised. One option is a UE-specific provision, which may lead to large signaling overhead when the number of UEs becomes large, and even larger signaling overhead considering that the radio environment changes over time. Another option is cell-specific broadcasting, which leads to large signaling overhead when the number of identified multi-path or radio objects becomes large, and even larger signaling overhead for repeated broadcasting in multi-beam systems. In multi-beam systems, the same content including all multi-path or radio objects within a coverage area of the base station is repeatedly transmitted over multiple base station beams.

### SUMMARY

According to an aspect of the disclosure, there is provided a method including receiving, by a user equipment (UE), per-beam radio path information or per-beam radio object information pertaining to radio paths or radio objects that are located within a coverage area of a base station beam.

Utilizing a radio environment notification that is transmitted as a per-beam broadcasting of multi-path information or of radio object information may reduce signaling overhead as compared with simple UE- or cell-specific signaling. Cell-specific multi-beam broadcasting information is typically repeated over all beams leading to excessive signaling overhead, whereas using a per-beam broadcasting enables the base station or network to only have to transmit information relevant for a given beam for that beam, not information for all beams over each beam.

In addition, utilizing a radio environment notification that is transmitted as a per-beam broadcasting of multi-path information or of radio object information may reduce memory requirements and power consumption at the UE. The UE may only keep track of a limited number of radio paths or radio objects within relevant beams.

Utilizing a radio environment notification that is transmitted using UE specific notification may enable reducing signaling overhead when managing radio paths or objects stored at the UE by referring to the radio path or radio object included in per-beam broadcasting or informing the difference with respect to the information included in per-beam broadcasting

In some embodiments, the per-beam radio path information or per-beam radio object information includes an association between an identifier of the base station beam and at least one of an identifier of a radio path or a radio object and information pertaining to the radio path or the radio object.

In some embodiments, the identifier of the radio path or the radio object is an identifier unique to the radio path or the radio object among multiple radio paths or radio objects within coverage area of the base station beam

In some embodiments, the identifier of the base station beam is at least one of a beam index, a synchronization signal-physical broadcast channel (SS-PBCH) block (SSB) index, or a reference signal (RS) resource index.

In some embodiments, the information pertaining to the radio path or the radio object includes at least one of radio object location, radio object size, incident angle of a signal being redirected by the radio object, redirection angle from the radio object, loss in signal strength due to redirection by the radio object or gain in signal strength due to redirection by the radio object.

In some embodiments, the method further includes transmitting, by the UE, capability information pertaining to a maximum number of radio paths or radio objects for which the UE is capable of storing information.

In some embodiments, receiving the per-beam radio path information or the per-beam radio object information occurs periodically or when the UE enters the coverage area of a new base station beam or when the UE is indicated with a new base station beam.

In some embodiments, the per-beam radio path information is location-dependent per-beam radio path information and the per-beam radio object information is location-dependent per-beam radio object information.

According to an aspect of the disclosure, there is provided a method including receiving, by a UE, UE-specific configuration information pertaining to storage or update of radio path information or radio object information.

In some embodiments, UE-specific configuration information is based on per-beam radio path information or per-beam radio object information pertaining to at least one radio path or at least one radio object that are located within a coverage area of a base station beam.

In some embodiments, the UE-specific configuration information includes an indication to add a radio path or radio object or remove a radio path or radio object from a list of radio paths or radio objects stored at the UE.

In some embodiments, adding the radio path or radio object includes adding information including at least one of radio object location, radio object size, incident angle of a signal being redirected by the radio object, redirection angle from the radio object, loss in signal strength due to redirection by the radio object, or gain in signal strength due to redirection by the radio object.

In some embodiments, the method further includes transmitting, by the UE, capability information pertaining to a maximum number of radio paths or radio objects for which the UE is capable of storing information.

In some embodiments, when the UE has stored information for less than a maximum number of radio paths or radio objects that the UE is capable of storing; adding, by the UE, information pertaining to at least one new radio path or radio object encountered in a base station beam; and maintaining, by the UE, previously stored information for radio paths or radio objects.

In some embodiments, when the UE has stored information for a maximum number of radio paths or radio objects that the UE is capable of storing: removing, by the UE, previously stored information pertaining to at least one radio path or radio object after being indicated with a new base station beam.

In some embodiments, the method further includes transmitting, by the UE, an indication of a change to at least one parameter associated with at least one radio path or radio object.

In some embodiments, the change is a result of the UE performing sensing and detecting the change to the at least one parameter associated with the at least one radio path or radio object as compared to the radio path information or radio object information stored at the UE.

In some embodiments, receiving the radio path information or the radio object information occurs periodically or when the UE enters the coverage area of a new base station beam or when the UE is indicated with a new base station beam.

In some embodiments, the radio path information is location-dependent radio path information and the radio object information is location-dependent radio object information.

According to an aspect of the disclosure, there is provided a device including a processor and a computer-readable storage media. The computer-readable storage media has stored thereon, computer executable instructions, that when executed by the processor, perform a method as described above or detailed below. The device may be a UE.

According to an aspect of the disclosure, there is provided a non-transitory computer readable storage medium, wherein the computer readable storage medium stores instructions that, when executed by a processor of an apparatus, enable the apparatus to perform a method as described above.

According to an aspect of the disclosure, there is provided a method including transmitting, by a base station, per-beam radio path information or per-beam radio object information pertaining to radio paths or radio objects that are located within a coverage area of a base station beam.

In some embodiments, the per-beam radio path information or per-beam radio object information includes an association between an identifier of the base station beam and at least one of an identifier of a radio path or a radio object and information pertaining to the radio path or the radio object.

In some embodiments, the identifier of the radio path or the radio object is an identifier unique to the radio path or the radio object among multiple radio paths or radio objects within coverage area of the base station beam

In some embodiments, the identifier of the base station beam is at least one of a beam index, a SSB index, or a RS resource index.

In some embodiments, the information pertaining to the radio path or the radio object includes at least one of radio object location, radio object size, incident angle of a signal being redirected by the radio object, redirection angle from the radio object, loss in signal strength due to redirection by the radio object or gain in signal strength due to redirection by the radio object.

In some embodiments, the method further includes receiving, by the base station, capability information pertaining to a maximum number of radio paths or radio objects for which a UE is capable of storing information.

In some embodiments, transmitting the per-beam radio path information or the per-beam radio object information occurs periodically or when the UE enters the coverage area of a new base station beam or when the UE is indicated with a new base station beam.

In some embodiments, the per-beam radio path information is location-dependent per-beam radio path information and the per-beam radio object information is location-dependent per-beam radio object information.

According to an aspect of the disclosure, there is provided a method including transmitting, by a base station, UE-specific configuration information pertaining to storage or update of radio path information or radio object information.

In some embodiments, UE-specific configuration information is based on per-beam radio path information or per-beam radio object information pertaining to at least one radio path or at least one radio object that are located within a coverage area of a base station beam.

In some embodiments, the UE-specific configuration information includes an indication to add a radio path or radio object or remove a radio path or radio object from a list of radio paths or radio objects stored at a UE.

In some embodiments, adding the radio path or radio object includes adding information including at least one of radio object location, radio object size, incident angle of a signal being redirected by the radio object, redirection angle from the radio object, loss in signal strength due to redirection by the radio object, or gain in signal strength due to redirection by the radio object.

In some embodiments, the method further includes receiving, by the base station, capability information pertaining to a maximum number of radio paths or radio objects for which the UE is capable of storing information.

In some embodiments, the method further includes receiving, by the base station, an indication of a change to at least one parameter associated with at least one radio path or radio object.

In some embodiments, the change is a result of the UE performing sensing and detecting the change to the at least one parameter associated with the at least one radio path or radio object as compared to the radio path information or radio object information stored at the UE.

In some embodiments, transmitting the radio path information or the radio object information occurs periodically or when the UE enters the coverage area of a new base station beam or when the UE is indicated with a new base station beam.

In some embodiments, the radio path information is location-dependent radio path information and the radio object information is location-dependent radio object information.

According to an aspect of the disclosure, there is provided a device including a processor and a computer-readable storage media. The computer-readable storage media has stored thereon, computer executable instructions, that when executed by the processor, perform a method as described above or detailed below. The device may be a base station.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram illustrating of a portion of a communication system in which various types of information that may be reported by a base station or network to a UE.

FIG. 2A is a schematic diagram of a communication system in which embodiments of the present disclosure may occur.

FIG. 2B is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5 is a schematic diagram of a portion of a communication system in which various types of objects are located between or around a base station and UE.

FIG. 6 is a schematic diagram of a portion of a communication system in which an object is located between a base station and multiple UEs that may act as a reflector, a blocker, or have no observable effect on radio propagation.

FIG. 7 is a table showing information that may be provided to UE by the network according to some embodiments of the disclosure.

FIG. 8 is a schematic diagram of a portion of a communication system in which various objects are located within a coverage area of a base station and information about these objects is broadcast on a per-beam basis according to some embodiments of the disclosure.

FIG. 9 is a table showing information that may be provided to the UE by the network according to some embodiments of the disclosure.

FIG. 10 is a schematic diagram of a portion of a communication system in which various objects are located within a coverage area of a base station and configuration information related to these objects is provided to the UE on a UE specific basis according to some embodiments of the disclosure.

FIG. 11 illustrates an example UE memory at different points in time showing how information may be removed or added to the UE memory by the network based on configuration information notification according to some embodiments of the disclosure.

FIG. 12 illustrates an example of a signaling flow diagram for transmission of configuration information in accordance with embodiments of the present disclosure.

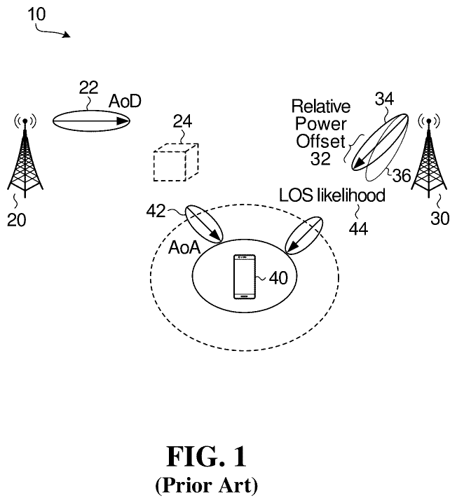

### DETAILED DESCRIPTION OF THE ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure also include methods for the base station or network to notify the UE about the radio environment with reduced signaling overhead in multi-beam systems.

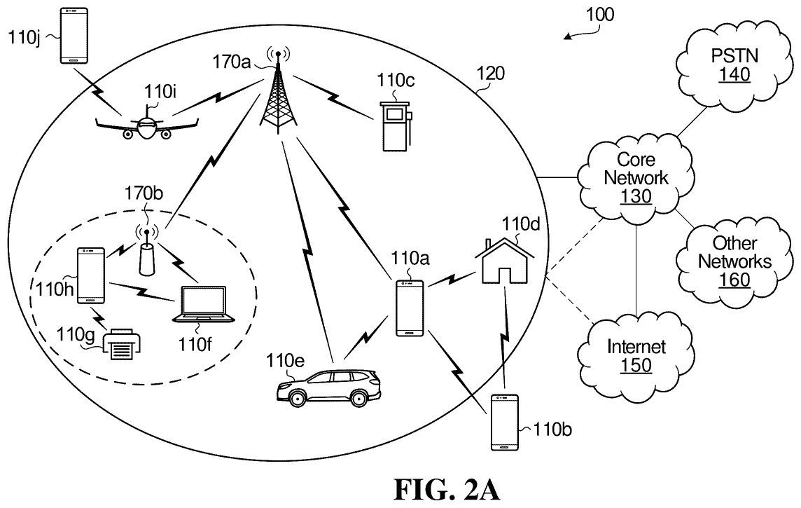

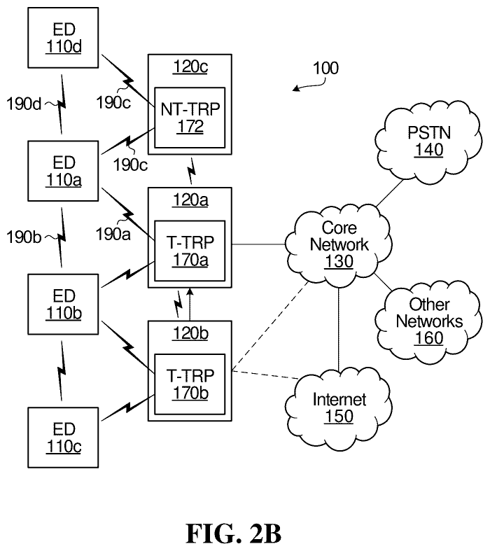

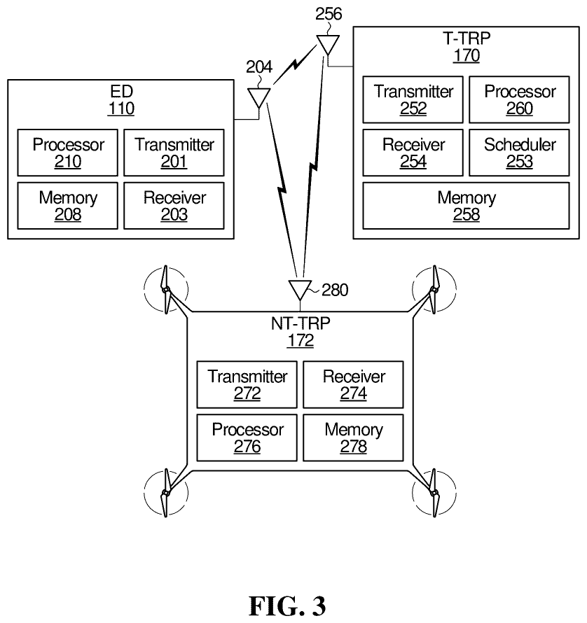

FIGS. 2A, 2B, and 3 following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

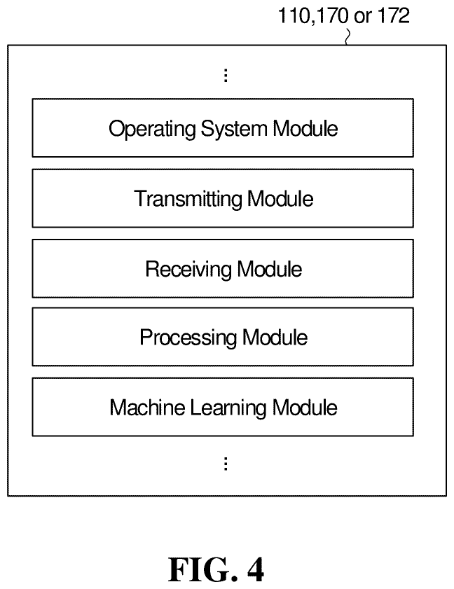

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

It is envisioned that sensing in a 6th Generation (6G) network may acquire and provide an accurate knowledge of radio propagation conditions with increased confidence. Radio propagation conditions may explicitly characterize existence of objects and the impact of those objects on radio wave propagation, including reflecting, blocking, absorbing, and attenuating. Hence, the objects that may affect radio wave propagation are referred to as radio objects. Radio propagation conditions may also be referred to as radio environment. An example of a use case for notifying the UE of a sensed or otherwise acquired map of the radio environment is to enable a UE to determine a receive beam after being notified of a base station transmit beam direction so that the base station and UE beam pair may provide sufficient signal reception quality for communication purposes. Another example of a use case for notifying the UE of a sensed and/or acquired map of the radio environment, is to enable a UE to determine a transmit beam after being notified of a base station receive beam direction so that the base station and UE beam pair may provide sufficient signal reception quality for communication purposes. A further example of a use case for notifying the UE of a sensed and/or acquired map of the radio environment, is to facilitate a UE to adjust ranging directions towards multiple reflectors (e.g., buildings) with known locations for better relative positioning of the UE. The term map here may indicate a list of radio objects that includes radio object identifiers and associated parameters that provides information about the radio objects.

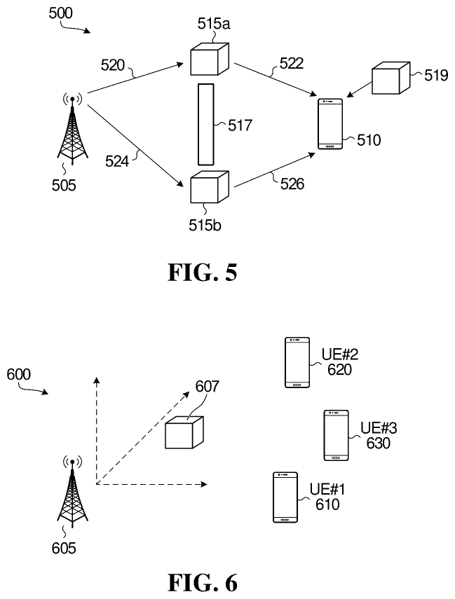

FIG. 5 illustrates a portion of a communication system 500 with a base station 505 and UE 510. There are also shown two objects 515a and 515b that act as reflectors of signals between the base station 505 and the UE 510, an object that acts as a blocker 517 of signals between the base station 505 and the UE 510, and an object 519 in the vicinity of the UE 510. The objects may be referred to as radio objects as they affect radio wave propagation between the base station 505 and the UE 510. The UE 510 may use sensing to help in determining relative position of the UE 510 with respect to one or more of the reflectors 515a, 515b, the blocker 517, and the object 519. The UE 510 may also use sensing to help in selecting receive beams for receiving signals from the base station 505. For example, selecting a receive beam direction 522 when the base station 510 transmits on a transmit beam direction 520 that reflects off of reflector 515a or a receive beam direction 526 when the base station 510 transmits on a transmit beam direction 524 that reflects off of reflector 515b.

As indicated above, there are several methods being considered as a part of 6G research with regard to how to represent a sensed and/or acquired radio environment. A first example method of how to represent a sensed and/or acquired radio environment is by using multi-path information for each possible UE location. The types of information that may be included in such multi-path information is information such as angle of departure (AoD) at a source, i.e. a base station for downlink or UE for uplink, angle of arrival (AoA) at the destination, i.e. a UE for downlink or base station for uplink, delay, gain or confidence level with regard to certainty of the information, etc. As a part of this first example, a database may be large when the candidate UE locations are listed with fine granularity.

A second example method of how to represent a sensed and/or acquired radio environment is by using radio objects, which may include information about the radio objects such as one or more of a location, a size, an incident angle, an outgoing angle, and a gain or a loss for each radio object. A radio object may be considered a reflector, a blocker, or neither of those types of objects because the radio object may have no, or negligible, impact on radio wave propagation between the base station and the UE, based on incident angle or outgoing angle, or UE location, or some combination thereof.

FIG. 6 illustrates a portion of a communication system 600 with a base station 605 and three UEs UE #1 610, UE #2 620 and UE #3 630. The dashed lines indicated a three dimensional space. There is also shown a radio object 607 that acts as a reflector of signals, acts as a blocker of signals, or does not affect radio wave propagation between the base station 605 and the UEs, depending on the location the radio object with regard to the UEs. The radio object 607 acts as a reflector for UE #1 610, where an outgoing angle of a beam or portion of a beam that is reflected by the radio object 607 is in the general direction of UE #1 610. The radio object 607 acts as a blocker for UE #2 620 because the radio object 607 is in direct path between the base station 605 and UE #2 620. The radio object 607 does not affect radio wave propagation between the base station 605 and UE #3 630 because the radio object 607 is not in a direct or reflecting path between the base station 605 and UE #3 630.

In the case of the second example method, the database may include one or more possible incident and outgoing angles leading to large signaling overhead when carried from base station or network to UE or reported from UE to base station or network.

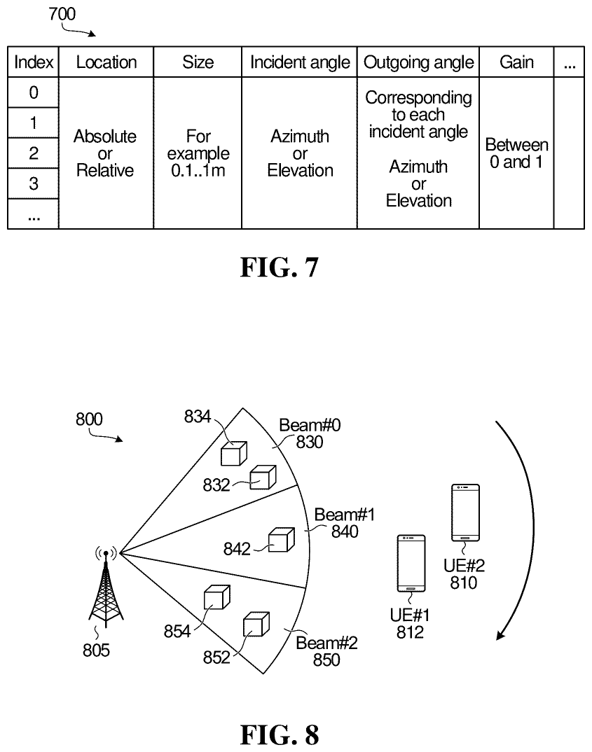

FIG. 7 shows an example of a table 700 that includes information for identifying radio objects including a radio object identifier that is an absolute index value of a radio object, and other parameters associated with the radio object. Examples of parameters that may be associated with the radio object include one or more of a location of the radio object, either in terms of absolute location information or relative location information with respect to the base station, a size of the radio object, an incident angle that may be an azimuth angle and/or an elevation angle, an outgoing angle for reflecting that may be an azimuth angle or an elevation angle, or both, and a gain for the reflected radio path. Additional parameters may also be included for each index. The gain may also be expressed as a loss. With regard to the incident angle, there may be multiple incident angles for a given radio object resulting in different gains for each respective angle. In addition, each incident angle value may result in or correspond to one or more outgoing angles that have different gains. A database may grow to quite a large size when there are multiple radio objects that each have multiple parameters and each radio object may have multiple entries for some of the parameter values, i.e. incident angle, outgoing angle, and gain.

Aspects of the present disclosure exploit that 1) radio paths or radio objects are located within different beams as seen from the perspective of the base station and 2) a UE may be of higher interest for the radio paths or radio objects within one or multiple base station beams that the UE has measured with good reception quality. Aspects of the present disclosure provide a radio environment notification method where a first notification is broadcast in a beam specific manner (i.e. any UEs within the coverage area of a given base station beam are able to receive the beam specific broadcast) that include information about the radio path or radio object within that base station beam. A second notification is transmitted in a UE specific manner (i.e. a given UE should receive the UE specific notification) that may pertain to configuration for storage or utilization, or both, of radio path or radio object information. In some embodiments, the radio path or radio object information received in the second notification may be related to information received at the UE in the first notification. In some embodiments, the first notification may be utilized by UEs in IDLE mode. In some embodiments, the second notification may be signaled to UEs in CONNECTED mode and the configuration of which may be relative to beam-specifically broadcasted ones in the first notification.

In some embodiments, a first type of radio environment notification may be transmitted as a per-beam broadcasting of radio path information or of radio object information. In some embodiments, the per-beam broadcasting may be transmitted in the form of system information (SI), such as master information block (MIB) or system information block (SIB).

FIG. 8 illustrates an example of various radio objects located at positions where the radio objects are considered to be within a coverage area of particular base station beams. There are three base station beams 830, 840 and 850 shown in FIG. 8 that the base station may use to transmit or receive. It is to be understood that three base station beams are merely used as an example in this figure and the number and size of base station beams are implementation specific. FIG. 8 illustrates a portion of a communication system 800 with a base station 805 and two UEs UE #2 810 and UE #1 812. There are two radio objects 832 and 834 within coverage area of base station beam 830. There is one radio object 842 within coverage area of base station beam 840. There are two radio objects 852 and 854 within coverage area of base station beam 850.

An association may be established between a base station beam and radio path(s) considered to be within the coverage area of the base station beam or between a base station beam and radio object(s) considered to be within the coverage area of the base station beam. In some embodiments, the base station beam may be represented by a reference signal or a synchronization signal-physical broadcast channel (SS-PBCH) block (SSB). In some embodiments, the base station beam may be represented in the form of a base station location, beam direction, and/or a base station beam width (e.g. half power beam width, HPBW). The association between the base station beam and radio paths or radio objects within the coverage area of the base station beam may be an explicit association or an implicit association. Examples of the association may include associating a base station beam index or a reference signal (RS) index or a beam direction to path angles or object locations, expressing path angles or object locations relative to a base station beam direction or a base station location.

To reduce signaling overhead of per-beam broadcasting of radio paths or radio objects within a coverage area of a base station beam, a local indexing scheme may be applied for radio paths or radio objects within the coverage area of one base station beam. An absolute index for a radio path may be considered as absolute radio path index=beam index*maximum number of radio paths per beam+local index. In this way, the local path or object index may have a smaller addressing space and thereby lower signaling overhead. In some embodiments, the beam index may be replaced by an SSB index, an RS resource index, etc. Alternatively, an absolute index for an absolute radio object index=beam index*maximum number of objects per beam+local index. In some embodiments, the beam index may be replaced as an SSB index, an RS resource index, etc.

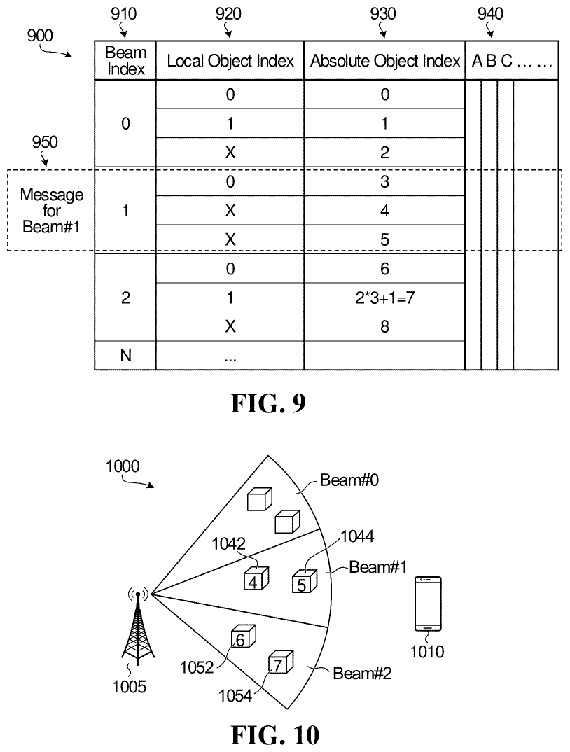

FIG. 9 is a tabular list 900 of information related to radio objects and radio paths that are located within the coverage area of multiple base station beams. A first column 910 of table 900 identifies base station beams by a beam index. In some embodiments, instead of using a beam index, an SSB index, an RS resource index, or another different index may be used. A second column 920 of table 900 identifies a radio object by a local object index. This may be an index that ranges from 0 to a maximum number of objects for each beam index. A third column 930 identifies a radio object by an absolute object index. This may be an index that ranges from 0 to a total number of objects for all the beam indices. The remainder of the columns 940 (A, B, C, etc.) are intended for various parameters that may be used to further define the radio object, such as the size of the radio object, an incident angle for a radio path, an outgoing angle of a radio path that is reflected by the radio object, and a gain for the reflected radio path. In the particular example of the table 900 in FIG. 9 it is assumed there are a maximum of 3 objects per beam. However, it is to be understood that maximum number of objects per beam would be implementation specific and may even vary from beam to beam. As an example of determining an absolute object index for a radio object, the absolute object index of the 2^{nd} object (having a local index of 1) in the base station beam identified with beam index 2 may be determined as beam index*maximum number of objects per beam+local index, i.e. 2*3+1=7. FIG. 9 also shows an example of information that may be included in a message 950 for Beam #1 of FIG. 8 that provided information about objects within the coverage area of Beam #1. The only object within the coverage area of Beam #1 in FIG. 8 is object 842, which has a local object index of 0 and an absolute object index of 3.

FIG. 9 is merely used as an example for ease of understanding, and it is to be understood that the beam index, maximum number of objects per beam, and local index values are all implementation specific values where the beam index and local index values may have starting values equal to 0. More generally, it is to be understood, that such absolute object index may be determined using other relationships when the starting value is equal to 0, or even, for example, if the starting value was 1, or some other number.

In some embodiments, when there is change in the radio environment, which may involve radio object movement, the broadcasted radio path or radio object information may be updated. The base station may transmit relevant radio path or radio object information periodically, which may change at different points in time, reflecting changes of the radio environment. A UE may receive such beam-specific broadcasting of radio path or radio object information periodically including information pertaining to the base station beam serving the UE or when the UE is indicated to receive from a new base station beam either after UE movement or as a result of base station selection. For example, in a particular scenario, an environment change may involve a radio object that is a car acting as a reflector within coverage area of one base station beam. At a given point in time, the car moved and is no longer a valid reflector for the coverage area of the base station beam, and it is then removed from subsequent broadcasting of radio path or radio object information for the base station beam.

In some embodiments, utilizing a radio environment notification that is transmitted as a per-beam broadcasting of multi-path information or of radio object information may reduce signaling overhead as compared with simple UE- or cell-specific signaling. Cell-specific multi-beam broadcasting information is typically repeated over all beams leading to excessive signaling overhead, whereas using a per-beam broadcasting enables the base station or network to only have to transmit information relevant for a given beam for that beam, not information for all beams over each beam.

In some embodiments, utilizing a radio environment notification that is transmitted as a per-beam broadcasting of multi-path information or of radio object information may reduce memory requirements and power consumption at the UE. The UE may only keep track of a limited number of radio paths or radio objects within relevant beams. For example, in some embodiments, a UE may only keep the radio objects within a serving base station beam.

In some embodiments, utilizing a radio environment notification that is transmitted as a per-beam broadcasting of multi-path information or of radio object information may enable early provision of the radio environment to facilitate initial access procedure. For example, the UE may refine a transmit beam for physical random access channel (PRACH) or message 3 (msg3) to potentially enable a higher success rate of random access procedure.

In some embodiments, a second type of radio environment notification may be transmitted that pertains to UE-specific management of stored or processed multi-path information or radio object information at the UE. In some embodiments, UE-specific management of stored or processed multi-path information or radio object information may pertain or refer to multi-path information or radio object information included in per-beam broadcasting of the first type of radio environment notification described above.

To provide a UE with accurate knowledge of the surrounding radio environment, a UE-specific configuration of radio paths or radio objects may be provided with a finer granularity than the per-beam broadcasting of the first type of radio environment notification described above. This UE-specific configuration of radio paths or radio objects may also enable the base station to add or remove multi-path information or radio object information that is stored by the UE in relation to multi-paths or radio objects included in per-beam broadcasting in the first type of radio environment notification, which may have a coarser granularity.

FIG. 10 illustrates an example of various radio objects located within the coverage area of various base station beams. There are three base station beams that the base station may use to transmit or receive that are similar to that shown in FIG. 8. FIG. 10 illustrates a portion of a communication system 1000 with a base station 1005 and a UE 1010. There are two radio objects within the coverage area of each of the base station beams. Radio object 1042, having an absolute radio object index of 4, and radio object 1044 having an absolute radio object index of 5, are located within the coverage area of base station beam Beam #1. Radio object 1052, having an absolute radio object index of 6, and radio object 1054, having an absolute radio object index of 7, are located within the coverage area of base station beam Beam #2.

In the example of FIG. 10, UE 1010 is located in proximity to an intersection of the coverage areas of base station beams Beam #1 and Beam #2. UE 1010 may store by default per-beam broadcasted information pertaining to radio object 1042 and 1044 when entering the coverage area of Beam #1. It is assumed in this example that a maximum memory size of UE 1010 for storing radio path or radio object information is for two radio path or radio objects. As an example of reducing signaling overhead, the base station 1005 may indicate that the UE 1010 should remove one of the objects within Beam #1 by referring to a local index of the radio object instead of referring to the absolute radio object index of that radio object, i.e. 4. With a maximum of two radio objects, the local radio object index may be a “o” or “1”. For up to eight radio objects spread over three beams, the absolute radio object index would be a value composed of at least three bits, i.e. “000” to “111”. The absolute radio object index has a larger addressing space, thereby using more signaling overhead than a local radio object index having a smaller addressing space.

As another example of reducing signaling overhead, the base station may indicate the UE should add a radio object using UE-specific signaling. Referring again to FIG. 10, the base station 1005 may indicate the UE 1010 should add radio object 1054 using UE-specific signaling.

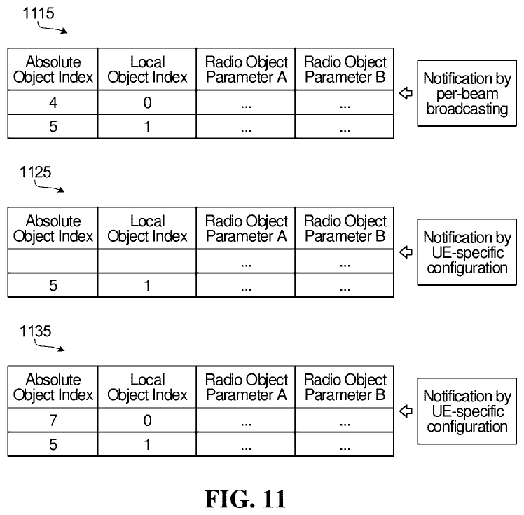

FIG. 11 illustrates an example UE memory at three different time instances. At a first time instance 1115, the UE 1010 receives a notification 1110 from the base station 1005 by a per-beam broadcast that includes description of two radio objects (e.g. radio objects 1042 and 1044 of FIG. 10) having an absolute radio object index and/or a local radio object index, as well as radio object parameters. At a second time instance 1125, the UE 1010 receives a notification 1120 from the base station 1005 by a UE specific signaling for the UE to remove one of the two radio objects from the memory using the local radio object index. At a third time instance 1135, the UE 1010 receives a notification 1130 from the base station 1005 by a UE specific signaling for the UE to add a new radio object to the memory. The UE-specific signaling may include detailed information of the added radio object, including radio object location, radio object size, incident angle, outgoing angle, loss or gain, etc.

Another example of reducing signaling overhead may involve the base station notifying the UE to add the 2^{nd} object within coverage area of base station beam Beam #2 using a local radio object index, instead of referring to the absolute radio object index of 7. In such an embodiment, the UE has previously either received per-beam broadcasted radio object information for both Beam #1 and Beam #2 or reported reception quality of these two beams to the base station. In the scenario in which the UE reports reception quality of the two beams, the base station is informed about the radio objects that the UE has acquired from per-beam broadcasting. The base station may then send UE-specific signaling (e.g. selecting which radio object to consider when the UE derives a receive beam based on an indicated base station transmit beam direction).

In some embodiments, in order to cope with potential UE memory limitations for storing and processing radio path information or radio object information, the UE may transmit UE capability information to the base station after the UE connects to the base station. The UE capability information indicates a maximum number of stored or processed radio paths or radio objects that the UE can store or process the related radio path information or radio object information. This may allow some UEs with more strong processing capability to inform the base station about the memory storage or processing capability of the UE, e.g. an appropriate number of stored or processed radio paths or radio objects.

In some embodiments, the UE may acquire and maintain information pertaining to radio paths or radio objects as the UE moves across base station beams. For example, after a UE is configured by the base station to acquire and maintain information, as long as a number of stored radio paths or radio objects has not reached a maximum value that the UE supports, the UE may add the radio path information or radio object information in a new or target base station beam into its memory and processing chain and at the same time keep information of previously stored radio paths or radio objects. This may reduce signaling overhead from using additional explicit configuration from the base station.

In some embodiments, when a number of configured radio paths or objects exceeds a maximum value that a UE supports, the UE may choose to drop information related to one or more radio paths or radio objects from the UE memory or processing chain based on one or more factors. Examples of such factors may include angle difference from the current beam direction from the base station or the UE perspective, distance between the radio object and the UE location, size of the radio object, reflecting gain or loss of the radio object, or time stamp of when the radio object was sensed or informed. The UE may implement a manner of dropping radio paths or radio objects in the form of a dropping rule. In some embodiments, the dropping rule may be defined based on factors mentioned above. In some embodiments, the dropping rule may be pre-defined (for example in telecommunication standards) and pre-stored at the UE. In some embodiments, the dropping rule may be configured by the base station via signaling. Allowing the UE to drop information related to one or more radio paths or radio objects based on a dropping rule which is known to the base station may add more flexibility to base station planning and configuration.

In some embodiments, in order to track changes of the radio environment, the UE may report changes of information related to radio paths or radio objects by referring to a radio path or radio object that is identified in the base station notification. For example, when a UE senses that a radio path or radio object, which has been configured by the base station, has shifted or moved beyond an angle threshold or a distance threshold, the UE may inform the base station about such a change. In some embodiments, the UE may also indicate an estimated size of the change to the base station. This may help the base station maintain an up-to-date database of the radio environment with lower signaling overhead.

In some embodiments, a UE specific notification method may enable reducing signaling overhead when managing radio paths or objects stored at the UE by referring to the radio path or radio object included in per-beam broadcasting or informing the difference with respect to the information included in per-beam broadcasting.

In some embodiments, a UE specific notification method may allow the UE to report a capability for storing radio paths or radio objects and enable the base station to exceed the UE capability with a dropping rule which is known to both the base station and the UE.

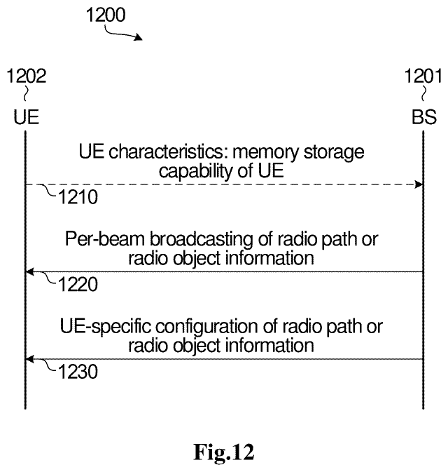

FIG. 12 illustrates an example of a signalling flow diagram 1200 for signaling with regard to a base station (BS) 1201 providing per-beam broadcast of radio object or radio path information and a base station 1201 providing UE-specific configuration of radio object or radio path information to a UE 1202.

Optional step 1210 may involve the UE 1202 sending UE capability information to the base station 1201. The UE capability information indicates a maximum number of radio paths or radio objects for which the UE 1202 may store or process.

Step 1220 involves the base station 1201 sending per-beam broadcast of radio object or radio path information. Such per-beam broadcast information sent by the base station 1201 includes a notification identifying a radio object and parameter information about the radio object or radio path. Identification of the radio object may include using a local radio object index or a local radio path index. The parameter information about the radio object or radio path may include one or more of the location of the radio object, either in terms of absolute location information or relative location information with respect to the base station location, the size of the radio object, an incident angle that may be an azimuth angle or an elevation angle, or both, an outgoing angle that may be an azimuth angle or an elevation angle, or both, and a gain or loss for the reflected radio path.

Step 1230 involves the base station 1201 sending UE-specific information to the UE 1202. Examples of types of information the base station 1201 may send includes a notification to remove a radio object or radio path using a local radio object index or local radio path index, a notification to add a radio object or radio path using an absolute radio object index or absolute radio path index, or a notification to add a radio object or radio path using a local radio object index or local radio path index.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method at a user equipment (UE), the method comprising:
receiving per-beam radio path information of radio paths that are located within a coverage area of a base station beam; or
receiving per-beam radio object information of radio objects that are located within the coverage area of the base station beam.

2. The method of claim 1, wherein the per-beam radio path information comprises an association between an identifier of the base station beam and at least one of an identifier of a radio path or information pertaining to the radio path; and
wherein the per-beam radio object information comprises an association between the identifier of the base station beam and at least one of an identifier of a radio object or information pertaining to the radio object.

3. The method of claim 2, wherein the identifier of the radio path is an identifier unique to the radio path among multiple radio paths within coverage area of the base station beam; and
wherein the identifier of the radio object is an identifier unique to the radio object among multiple radio objects within coverage area of the base station beam.

4. The method of claim 2, wherein the identifier of the base station beam is at least one of a beam index, a synchronization signal-physical broadcast channel (SS-PBCH) block (SSB) index, or a reference signal (RS) resource index.

5. The method of claim 2, wherein the information pertaining to the radio path or the information pertaining to the radio object comprises at least one of radio object location, radio object size, incident angle of a signal being redirected by the radio object, redirection angle from the radio object, loss in signal strength due to redirection by the radio object or gain in signal strength due to redirection by the radio object.

6. A device comprising:
at least one processor; and
a computer-readable storage media, having stored thereon, computer executable instructions, that when executed by the at least one processor, cause the device to perform operations comprising:
receiving per-beam radio path information of radio paths that are located within a coverage area of a base station beam; or
receiving per-beam radio object information pertaining to radio objects that are located within the coverage area of the base station beam.

7. The device of claim 6, wherein the per-beam radio path information comprises an association between an identifier of the base station beam and at least one of an identifier of a radio path or information pertaining to the radio path; and
wherein the per-beam radio object information comprises an association between the identifier of the base station beam and at least one of an identifier of a radio object or information pertaining to the radio object.

8. The device of claim 7, wherein the identifier of the radio path is an identifier unique to the radio path among multiple radio paths within coverage area of the base station beam; and
wherein the identifier of the radio object is an identifier unique to the radio object among multiple radio objects within coverage area of the base station beam.

9. The device of claim 7, wherein the identifier of the base station beam is at least one of a beam index, a synchronization signal-physical broadcast channel (SS-PBCH) block (SSB) index, or a reference signal (RS) resource index.

10. The device of claim 7, wherein the information pertaining to the radio path or the radio object comprises at least one of radio object location, radio object size, incident angle of a signal being redirected by the radio object, redirection angle from the radio object, loss in signal strength due to redirection by the radio object or gain in signal strength due to redirection by the radio object.

11. A method at a base station, the method comprising:
transmitting per-beam radio path information of radio paths that are located within a coverage area of a base station beam; or
transmitting per-beam radio object information of radio objects that are located within the coverage area of the base station beam.

12. The method of claim 11, wherein the per-beam radio path information comprises an association between an identifier of the base station beam and at least one of an identifier of a radio path or information pertaining to the radio path; and
wherein the per-beam radio object information comprises an association between the identifier of the base station beam and at least one of an identifier of a radio object or information pertaining to the radio object.

13. The method of claim 12, wherein the identifier of the radio path is an identifier unique to the radio path among multiple radio paths within coverage area of the base station beam; and
wherein the identifier of the radio object is an identifier unique to the radio object among multiple radio objects within coverage area of the base station beam.

14. The method of claim 12, wherein the identifier of the base station beam is at least one of a beam index, a synchronization signal-physical broadcast channel (SS-PBCH) block (SSB) index, or a reference signal (RS) resource index.

15. The method of claim 11, wherein the information pertaining to the radio path or the radio object comprises at least one of radio object location, radio object size, incident angle of a signal being redirected by the radio object, redirection angle from the radio object, loss in signal strength due to redirection by the radio object or gain in signal strength due to redirection by the radio object.

16. A device comprising:
at least one processor; and
a computer-readable storage media, having stored thereon, computer executable instructions, that when executed by the at least one processor, cause the device to perform operations comprising:
transmitting per-beam radio path information of radio paths that are located within a coverage area of a base station beam; or
transmitting per-beam radio object information of radio objects that are located within the coverage area of the base station beam.

17. The device of claim 16, wherein the per-beam radio path information comprises an association between an identifier of the base station beam and at least one of an identifier of a radio path or information pertaining to the radio path; and
wherein the per-beam radio object information comprises an association between the identifier of the base station beam and at least one of an identifier of a radio object or information pertaining to the radio object.

18. The device of claim 17, wherein the identifier of the radio path is an identifier unique to the radio path among multiple radio paths within coverage area of the base station beam; and
wherein the identifier of the radio object is an identifier unique to the radio object among multiple radio objects within coverage area of the base station beam.

19. The device of claim 17, wherein the identifier of the base station beam is at least one of a beam index, a synchronization signal-physical broadcast channel (SS-PBCH) block (SSB) index, or a reference signal (RS) resource index.

20. The device of claim 16, wherein the information pertaining to the radio path or the radio object comprises at least one of radio object location, radio object size, incident angle of a signal being redirected by the radio object, redirection angle from the radio object, loss in signal strength due to redirection by the radio object or gain in signal strength due to redirection by the radio object.
